(19) United States
(12) Patent Application Publication
(10) Pub. No.: US 2025/0173176 A1
(43) Pub. Date: May 29, 2025

(54) VIRTUAL MACHINE SCHEDULING METHOD, ELECTRONIC DEVICE AND STORAGE MEDIUM

(71) Applicant: Beijing Volcano Engine Technology Co., Ltd., Beijing (CN)

(72) Inventors: Yunfei LIZHAO, Beijing (CN); Bo ZHU, Beijing (CN)

(21) Appl. No.: 18/962,018

(22) Filed: Nov. 27, 2024

(30) Foreign Application Priority Data
Nov. 27, 2023 (CN) 202311599938.5

(51) Int. Cl. G06F 9/455; G06F 9/50

(52) U.S. Cl. CPC G06F 9/45558; G06F 9/5027; G06F 2009/4557; G06F 2009/45595

(57) ABSTRACT

A virtual machine scheduling method, an electronic device and a storage medium. The method includes: acquiring optimal resource distribution information of a plurality of physical machines in a cloud computing system, wherein the optimal resource distribution information includes specifications and numbers of specifications of virtual machine instances expected to be deployed on idle resources of the plurality of physical machines; for a first to-be-deployed virtual machine instance, determining a score of matching degree between each physical machine and the first to-be-deployed virtual machine instance based on the optimal resource distribution information; and determining the physical machine with the highest score of matching degree as a host machine of the first to-be-deployed virtual machine instance, for resource allocation.

### CROSS-REFERENCE TO RELATED APPLICATION

The application claims the priority of Chinese Patent Application No. 202311599938.5 filed on Nov. 27, 2023, the entire contents of which are incorporated herein by reference as a part of embodiments of this application.

### TECHNICAL FIELD

Embodiments of the present disclosure relate to the technical field of computer and network communication, for example, to a virtual machine scheduling method and apparatus, an electronic device and a storage medium.

### BACKGROUND

In the field of cloud computing, the optimization of resource distribution is mainly realized by virtual machine scheduling to achieve the optimal state of overall resource cost and risk. The objective of virtual machine scheduling is to find the suitable underlying physical machine for the virtual machine, and migrate the resources of the virtual machine by calculating the migration path thereof, so as to achieve the specific objective of scheduling services.

Existing virtual machine scheduling method is usually divided into primary scheduling and secondary scheduling. The primary scheduling is to allocate physical machines for the virtual machine instances to be deployed for the first time, while the secondary scheduling is to rearrange the deployed virtual machines in all the physical machines to enable the overall resource distribution to be reasonable through migration.

The existing virtual machine scheduling needs to be performed through cooperation of primary scheduling and secondary scheduling. The results of primary scheduling usually have poor accuracy in order to ensure real-time performance, which further leads to long time consumption when resources are rearranged by secondary scheduling; further, more virtual machines need to be migrated, and ultimately the overall scheduling cost is expensive, which affects the upper-level service experience.

### SUMMARY

Embodiments of the present disclosure provide a virtual machine scheduling method and apparatus, an electronic device, and a storage medium, which allows resource allocation in a cloud computing system to be more reasonable, and improves the efficiency and accuracy of resource scheduling.

An embodiment of the present disclosure provides a virtual machine scheduling method, including:
acquiring optimal resource distribution information of a plurality of physical machines in a cloud computing system, wherein the optimal resource distribution information includes specifications and numbers of the specifications of virtual machine instances expected to be deployed on idle resources of the plurality of physical machines;
for a first to-be-deployed virtual machine instance, determining a score of matching degree between each physical machine and the first to-be-deployed virtual machine instance based on the optimal resource distribution information;
determining the physical machine with the highest score of matching degree as a host machine of the first to-be-deployed virtual machine instance for resource allocation.

An embodiment of the present disclosure provides a virtual machine scheduling apparatus, including:
a pre-scheduling unit, configured to acquire optimal resource distribution information of a plurality of physical machines in a cloud computing system, wherein the optimal resource distribution information includes specifications and numbers of the specifications of virtual machine instances expected to be deployed on idle resources of the plurality of physical machines;
an evaluation unit, configured to, for a first to-be-deployed virtual machine instance, determine a score of matching degree between each physical machine and the first to-be-deployed virtual machine instance based on the optimal resource distribution information; and
a scheduling unit, configured to determine the physical machine with a highest score of matching degree as a host machine of the first to-be-deployed virtual machine instance for resource allocation.

An embodiment of the present disclosure provides an electronic device, including at least one processor and a memory stored with computer-executable instructions;
the at least one processor is configured to execute the computer-executed instructions stored in the memory to realize the virtual machine scheduling method as described in the above embodiment and in the various possible designs of the above embodiment.

An embodiment of the present disclosure provides a non-transient computer-readable storage medium in which computer-executable instructions are stored, wherein the computer-executable instructions, when executed by a processer, are configured to cause the processer to realize the virtual machine scheduling method as described in the above embodiment and in the various possible designs of the above embodiment.

An embodiment of the present disclosure provides a computer program product, including computer-executed instructions, wherein the computer-executable instructions, when executed by a processer, are configured to cause the processer to realize the virtual machine scheduling method as described in the above embodiment and in the various possible designs of the above embodiment.

### BRIEF DESCRIPTION OF DRAWINGS

In order to explain the embodiments of the present disclosure or the technical solutions in the prior art more clearly, the drawings necessary for the description of the embodiments or the prior art will be briefly introduced below. Obviously, the drawings in the following description are some embodiments of the present disclosure, and other drawings can be obtained according to these drawings without creative labor.

FIG. 1 is a schematic diagram illustrating a scenario of a virtual machine scheduling method provided by an embodiment of the present disclosure;

FIG. 2 is a flowchart of a virtual machine scheduling method provided by an embodiment of the present disclosure;

FIG. 3 is a schematic diagram illustrating acquiring optimal resource distribution information of a plurality of physical machines according to an embodiment of the present disclosure;

FIG. 4 is a schematic diagram illustrating a score of matching degree between any physical machine and a to-be-deployed virtual machine instance according to an embodiment of the present disclosure;

FIG. 5 is a block diagram illustrating a structure of a virtual machine scheduling apparatus provided by an embodiment of the present disclosure; and

FIG. 6 is a schematic diagram illustrating a hardware structure of an electronic device provided by an embodiment of the present disclosure.

### DETAILED DESCRIPTION

In order to make the objective(s), technical solution(s) and advantages of the embodiments of the present disclosure more definite, the technical solution(s) in the embodiments of the present disclosure will be described clearly and completely in conjunction with the accompanying drawings. Obviously, the described embodiments merely are part of but not all of the embodiments of the present disclosure. Based on the embodiments in the present disclosure, all other embodiments obtained by those ordinary skilled in the art without creative work fall within the scope of protection of the present disclosure.

Existing virtual machine scheduling method is usually divided into primary scheduling and secondary scheduling. The primary scheduling is to allocate physical machines for virtual machine instances to be deployed for the first time. In the related technology, the mode including filtering (filter), scoring (scorer) and selecting (selector) is adopted, in which the filtering is to filter the physical machines under certain conditions firstly, and the scoring is to score the physical machines from multiple dimensions, and the selecting is to finally select the appropriate physical machine according to the ranking based on scores. The secondary scheduling is to rearrange the deployed virtual machines among all the physical machines, and migrate the selected virtual machines through certain judgment conditions or algorithms based on the attribute information of the deployed virtual machines, to enable the overall resource distribution to be reasonable through migration.

The existing virtual machine scheduling method needs to be performed through cooperation of primary scheduling and secondary scheduling. In order to ensure real-time performance, the results of primary scheduling usually have poor accuracy. The primary scheduling process only selects a locally optimal physical machine for the virtual machines to be deployed according to current resources but cannot achieve globally optimal, overall distribution optimization, which involves the deficiency in the overall accuracy of scheduling and has negative impacts on the overall resource distribution, for example, a large number of fragmented resources that cannot be utilized may be generated. Furthermore, due to the low accuracy and efficiency of the primary scheduling, the secondary scheduling takes a longer time and there are a huge number of virtual machines that need to be migrated, which may have a certain impact on the overall stability of virtual machine instances; moreover, the expensive migration cost may affect the upper-level service experience.

In order to solve the above technical problems, the present disclosure provides a virtual machine scheduling method, including: acquiring optimal resource distribution information of a plurality of physical machines in a cloud computing system, wherein the optimal resource distribution information includes specifications and numbers of the specifications of virtual machine instances expected to be deployed on idle resources of the plurality of physical machines; for a first to-be-deployed virtual machine instance, determining a score of matching degree between each physical machine of the plurality of physical machines and the first to-be-deployed virtual machine instance based on the optimal resource distribution information; and determining the physical machine with a highest score of matching degree as a host machine of the first to-be-deployed virtual machine instance for resource allocation. When allocating the to-be-deployed virtual machine instances to the physical machines, the optimal resource distribution information of a plurality of physical machines in the cloud computing system is taken into consideration. For example, the specifications and numbers of the virtual machine instances that are expected to be deployed on the idle resources of the plurality of physical machines in the optimal resource distribution information are taken into consideration, which enables the resource allocation to be more reasonable, reduces the generation of unavailable fragmented resources, and improves the efficiency and accuracy of resource scheduling; furthermore, it can also reduce the number of virtual machines that need to be migrated during secondary scheduling, avoid affecting the overall stability of virtual machine instances, and lower the migration cost.

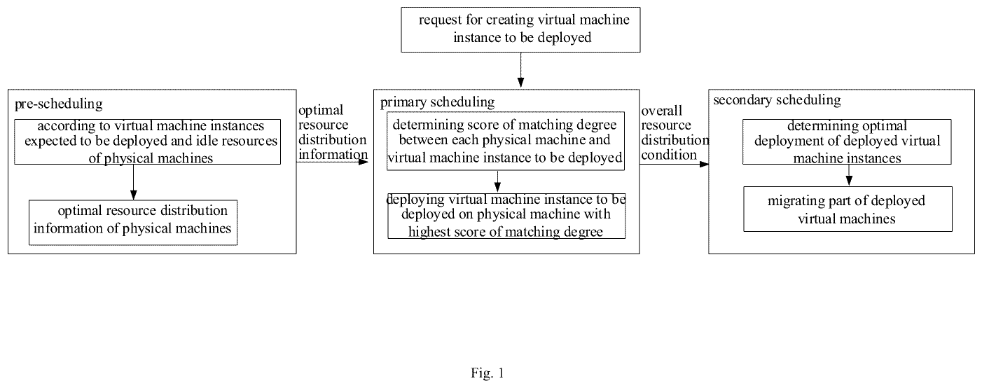

As shown in FIG. 1, a pre-scheduling process is added to the virtual machine scheduling method provided by the present disclosure. In the pre-scheduling process, optimal resource distribution information of a plurality of physical machines in the cloud computing system can be acquired, wherein the optimal resource distribution information includes specifications and numbers of specifications of virtual machine instances expected to be deployed on idle resources of the plurality of physical machines, and the optimal resource distribution information can be determined according to all specifications of the virtual machine instances expected to be deployed, numbers corresponding to different specifications, and number information of idle resources of each physical machine. During the primary scheduling, when a request for creating a to-be-deployed virtual machine instance is received, a score of matching degree between each physical machine and the to-be-deployed virtual machine instance can be determined by taking the optimal resource deployment information into account, and a physical machine with the highest score of matching degree is determined as a host machine of the to-be-deployed virtual machine instance for resource allocation. During secondary scheduling, an optimal deployment of deployed virtual machine instances on each physical machine can be determined based on an overall resource distribution and other information of the plurality of physical machines, and then some of the deployed virtual machine instances can be migrated according to the optimal deployment. Because of the pre-scheduling and primary scheduling, the resource allocation is more reasonable, and the efficiency and accuracy of resource scheduling are improved. On this basis, the number of deployed virtual machines that need to be migrated during the secondary scheduling is greatly reduced, and the migration cost is lowered, in which the secondary scheduling is not a necessary step and may not be performed.

Hereinafter, the virtual machine scheduling method of the present disclosure will be introduced in details with reference to exemplary embodiments.

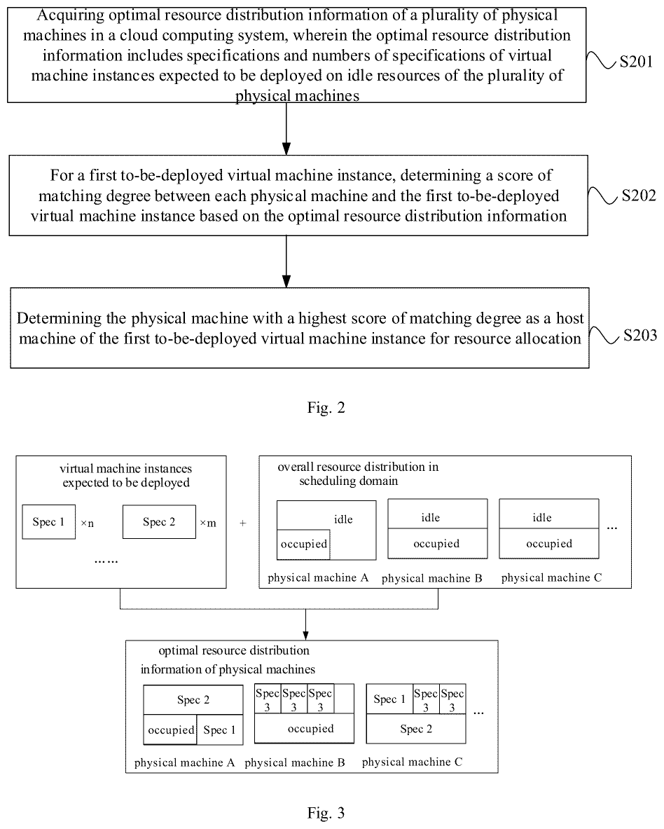

Referring to FIG. 2, FIG. 2 is a flowchart of a virtual machine scheduling method provided by an embodiment of the present disclosure. The method of this embodiment can be applied to a terminal device or a server, and the virtual machine scheduling method includes:

S201, acquiring optimal resource distribution information of a plurality of physical machines in a cloud computing system, wherein the optimal resource distribution information includes specifications and numbers of specifications of virtual machine instances expected to be deployed on idle resources of the plurality of physical machines.

In this embodiment, specifications and numbers of virtual machine instances expected to be deployed on idle resources of a plurality of physical machines in the cloud computing system can be acquired as the optimal resource distribution information of the plurality of physical machines in the cloud computing system, to provide a basis for subsequent virtual machine resource scheduling.

Optionally, as shown in FIG. 3, all the specifications of the virtual machine instances expected to be deployed on the idle resources of all the physical machines in the scheduling domain and numbers corresponding to different specifications can be acquired; that is, the sales plan of the cloud computing system for virtual machine instances in the future or the plan to provide virtual machine instances for customers; for example, it is expected to sell n virtual machine instances of specification 1 and m virtual machine instances of specification 2 within a predetermined time in the future, and so on. All the specifications of specific virtual machine instances expected to be deployed and the numbers corresponding to different specifications can be determined according to actual requirements, which can be fixed or dynamically changed, for example, it may be periodically modified. In addition, it is also necessary to acquire number information of idle resources of the plurality of physical machines. After knowing all the specifications of the virtual machine instances expected to be deployed, the numbers corresponding to different specifications, and the number information of idle resources of the plurality of physical machines, a specific algorithm can be adopted to determine an optimal distribution mode of deploying the virtual machine instances expected to be deployed on the idle resources of the plurality of physical machines, so as to acquire the optimal resource distribution information.

According to an embodiment of the present disclosure, it can simulate to deploy the virtual machine instances expected to be deployed on the idle resources of the plurality of physical machines, and the deployment mode with the highest resource utilization rate can be selected, so that the specifications and the numbers of the specifications of the virtual machine instances expected to be deployed on the idle resources of each physical machine can be acquired; that is, the optimal resource distribution information can be acquired. For example, k virtual machine instances of specification 1 and 1 virtual machine instance of specification 2 are expected to be deployed on a physical machine A, p virtual machine instances of specification 2 and q virtual machine instances of specification 3 are expected to be deployed on a physical machine B. In the process of simulated deployment, the deployment can be performed according to the order from large specification to small specification. For example, for the physical machine with the greatest number of idle resources, the virtual machine instance with the largest specification is given with the priority for deploying, and so on. Of course, other algorithms can also be used to determine the deployment mode, which is not limited here.

It should be noted that the above exemplary process of calculating the optimal resource distribution information of a plurality of physical machines can be performed periodically, the calculated optimal resource distribution information can be stored, and the pre-stored optimal resource distribution information can be acquired when virtual machine scheduling is needed.

S202, for a first to-be-deployed virtual machine instance, determining a score of matching degree between each physical machine and the first to-be-deployed virtual machine instance based on the optimal resource distribution information.

It should be note that, according to the embodiments of the present disclosure, the first to-be-deployed virtual machine instance can be any virtual machine instance to be deployed.

In this embodiment, when receiving a request from a customer to purchase a new virtual machine instance or to create a virtual machine instance, or in other cases where it is necessary to allocate resources for a first to-be-deployed virtual machine instance, a matching degree between each physical machine and the first to-be-deployed virtual machine instance can be scored with reference to the above optimal resource distribution information so as to obtain the score of matching degree between each physical machine and the first to-be-deployed virtual machine instance. According to an embodiment of the present disclosure, for a first physical machine, if the specifications of the virtual machine instances expected to be deployed on the idle resources of the first physical machine include the specification of the first to-be-deployed virtual machine instance, the greater the number of the specification of the first to-be-deployed virtual machine instance included in the specifications of the virtual machine instances expected to be deployed on the idle resources of the first physical machine is, the higher the score of matching degree corresponding to the first physical machine will be, which is beneficial to more preferentially deploying the first to-be-deployed virtual machine instance on the first physical machine.

It should be noted that, according to the embodiments of the present disclosure, similarly, the first physical machine can be any physical machine.

Optionally, when determining the score of matching degree between each physical machine and the first to-be-deployed virtual machine instance, various factors can be taken into consideration. For example, the score of matching degree between each physical machine and the first to-be-deployed virtual machine instance can be determined according to the optimal resource distribution information, the information of each physical machine and the information of the first to-be-deployed virtual machine instance. The information of physical machine includes, but is not limited to, the stacking degree of the physical machine, the performance of the physical machine, etc.; the information of the first to-be-deployed virtual machine instance includes, but is not limited to, the specification of the first to-be-deployed virtual machine instance, the service requirements (such as the required performance, thermal migration requirements and load size) of the first to-be-deployed virtual machine instance, etc.

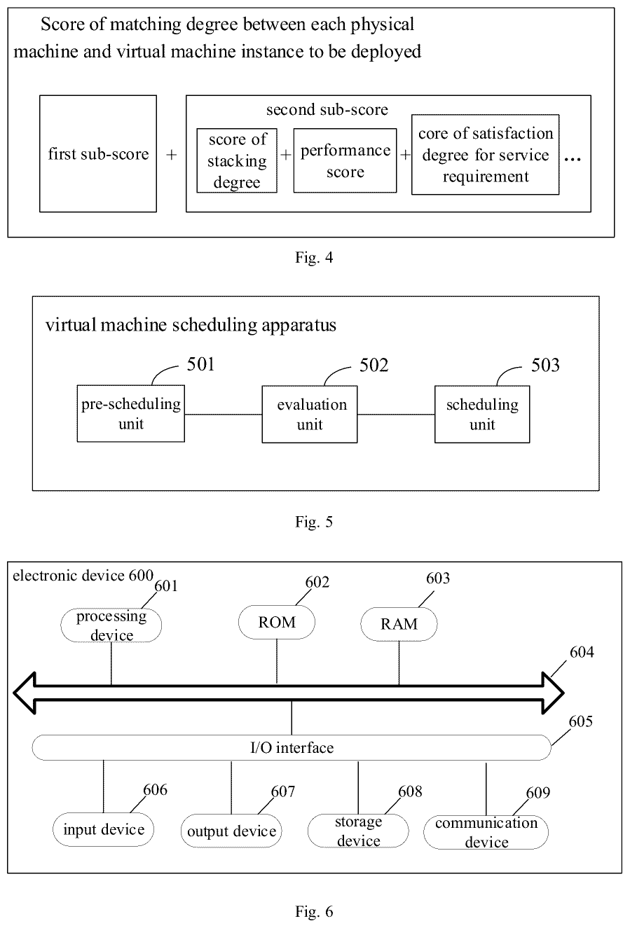

According to an embodiment of the present disclosure, as shown in FIG. 4, when determining the score of matching degree between each physical machine and the first to-be-deployed virtual machine instance according to the optimal resource distribution information, the information of each physical machine, and the information of the first to-be-deployed virtual machine instance, it may include:
determining a first sub-score of matching degree between a first physical machine and the first to-be-deployed virtual machine instance according to the specifications and numbers of the virtual machine instances expected to be deployed on the idle resources of the first physical machine in the optimal resource distribution information, and the specification of the first to-be-deployed virtual machine instance; wherein the first sub-score is a score obtained by evaluating the matching degree between the first physical machine and the first to-be-deployed virtual machine instance based on the optimal resource distribution information;
determining a second sub-score of matching degree between the first physical machine and the first to-be-deployed virtual machine instance according to the information of the first physical machine and the information of the first to-be-deployed virtual machine instance; wherein the second sub-score is a score obtained by evaluating the matching degree between the first physical machine and the first to-be-deployed virtual machine instance based on the information of the first physical machine and the information of the first to-be-deployed virtual machine instance; and
adding up the first sub-score and the second sub-score to obtain a sum as the score of matching degree between the first physical machine and the first to-be-deployed virtual machine instance.

In this embodiment, for any physical machine (e.g., the first physical machine), the first sub-score is a score obtained with reference to the optimal resource distribution information and the specification information included in the information of the first to-be-deployed virtual machine instance, while the second sub-score is a score obtained based on other information including the information of each physical machine and the information of the first to-be-deployed virtual machine instance (the reference may not be made to the optimal resource distribution information). By adding up the first sub-score and the second sub-score (direct addition or weighted addition), the score of matching degree between the physical machine and the first to-be-deployed virtual machine instance can be obtained.

In an embodiment, the process of obtaining the first sub-score of matching degree between the first physical machine and the first to-be-deployed virtual machine instance may include: judging whether the specification of the first to-be-deployed virtual machine instance is included in the specifications of the virtual machine instances expected to be deployed on the idle resources of the first physical machine; if not, the first sub-score is determined to be 0, that is, the first physical machine does not match the first to-be-deployed virtual machine instance; if so, the first sub-score is determined according to the number of the specification of the first to-be-deployed virtual machine instance included in the specifications of the virtual machine instances expected to be deployed on the idle resources of the first physical machine; the greater the number is, the higher the first sub-score will be; for example, given that the specification of the first to-be-deployed virtual machine instance is specification 1, three virtual machine instances with specification 1 are expected to be deployed on the idle resources of the physical machine A, and two virtual machine instances with specification 1 are expected to be deployed on the idle resources of the physical machine B, then the first sub-score corresponding to the physical machine A is greater than the first sub-score corresponding to the physical machine B, and the specific value of the first sub-score can be determined according to specific algorithm or mapping relationship, which is not limited here.

In an embodiment, the process of obtaining the second sub-score of matching degree between the first physical machine and the first to-be-deployed virtual machine instance may include obtaining one or more of the following scores, and determining a sum of the obtained scores as the second sub-score: a score of stacking degree of the first physical machine, a performance score of the first physical machine, a score of satisfaction degree of the first physical machine for service requirement of the first to-be-deployed virtual machine instance, an affinity score of the first physical machine with respect to the first to-be-deployed virtual machine instance, and a score of instance number of deployed virtual machine instances of the first physical machine.

According to an embodiment of the present disclosure, the score of stacking degree of the first physical machine can be determined according to the stacking degree of the first physical machine; and/or, the performance score of the first physical machine can be determined according to the performance of the first physical machine; and/or, the score of satisfaction degree of the first physical machine for the service requirements of the first to-be-deployed virtual machine instance can be determined according to the service requirements of the first to-be-deployed virtual machine instance; and/or, the affinity score of the first physical machine can be determined according to a preset service tag of the first physical machine and a service tag of the first to-be-deployed virtual machine instance; and/or, the score of instance number of the first physical machine can be determined according to the number of deployed virtual machine instances of the first physical machine.

In this embodiment, it can be scored according to the information of the physical machine and the information of the to-be-deployed virtual machine instance from different dimensions, and the scores are finally added up to obtain the second sub-score (alternatively, the second sub-score in the above embodiment can be directly replaced with the scores of various dimensions in this embodiment, which is only for purpose of convenient description here). For example, the score of stacking degree of a physical machine refers to the evaluation of how the physical machine is suitable for deploying with virtual machine instances from the perspective of stacking degree of the physical machine; the performance score of a physical machine refers to the evaluation of whether the physical machine is suitable for deploying with virtual machine instances from the perspective of the performance of the physical machine; the score of satisfaction degree for service requirements refers to the evaluation of whether the service requirements are satisfied when the to-be-deployed virtual machine instance is deployed on a certain physical machine from the perspective of service requirements of the to-be-deployed virtual machine instance; the affinity score refers to the evaluation of affinity degree between a physical machine and the to-be-deployed virtual machine instance from the perspective of the matching degree between a preset service tag of the physical machine and the service tag of the to-be-deployed virtual machine instance, and the higher the matching degree is, the higher the affinity score will be; the score of instance number considers the number of virtual machine instances deployed on a physical machine will also affect the matching degree between the physical machine and the to-be-deployed virtual machine instance, and if the number of virtual machine instances deployed on a physical machine is greater, it is less suitable to deploy the to-be-deployed virtual machine instance on the physical machine, and the score of instance number is lower.

Any feasible method can be used to evaluate the score of stacking degree of the physical machine, the performance score of the physical machine, the satisfaction score for service requirements, the affinity score, the score of instance number and the like, which is not limited here; and the second sub-score may include, but not be limited to, one or more of the above scores.

S203, determining the physical machine with a highest score of matching degree as a host machine of the first to-be-deployed virtual machine instance for resource allocation.

In this embodiment, after the score of matching degree corresponding to each physical machine is calculated in the above embodiment, the physical machine with the highest score of matching degree can be determined as the host machine of the first to-be-deployed virtual machine instance, and resources can be allocated on the host machine to realize the deployment of the first to-be-deployed virtual machine instance.

In the virtual machine scheduling method provided by this embodiment, acquiring optimal resource distribution information of a plurality of physical machines in a cloud computing system, wherein the optimal resource distribution information includes specifications and numbers of specifications of virtual machine instances expected to be deployed on idle resources of the plurality of physical machines; for a first to-be-deployed virtual machine instance, determining a score of matching degree between each physical machine and the first to-be-deployed virtual machine instance based on the optimal resource distribution information; and determining the physical machine with the highest score of matching degree as a host machine of the first to-be-deployed virtual machine instance for resource allocation. When allocating the to-be-deployed virtual machine instances to the physical machines, the optimal resource distribution information of a plurality of physical machines in the cloud computing system is taken into consideration, which enables the resource allocation to be more reasonable, reduces the generation of unavailable fragmented resources, and improves the efficiency and accuracy of resource scheduling.

In an embodiment, before determining the score of matching degree between each physical machine and the first to-be-deployed virtual machine instance based on the optimal resource distribution information in S202, it may further include filtering out unavailable physical machines from the plurality of physical machines in the cloud computing system, wherein the unavailable physical machines include one or more of the following: physical machines with idle resources less than the specification of the first to-be-deployed virtual machine instance, physical machines with abnormal working conditions, and physical machines not matching the service requirements of the first to-be-deployed virtual machine instance.

In this embodiment, considering that the process of obtaining the score of matching degree takes a long time and occupies computing resources, the unavailable physical machines among the plurality of physical machines in the cloud computing system can be filtered out before obtaining the score of matching degree, and there is no need to calculate these unavailable physical machines in the process of obtaining the score of matching degree, thus improving the efficiency of the process of obtaining the score of matching degree and saving computing resources. The unavailable physical machines include, but are not limited to, physical machines with idle resources less than the specification of the first to-be-deployed virtual machine instance (that is, physical machines with resources insufficient to be deployed with the first to-be-deployed virtual machine instance), physical machines with abnormal working conditions (e.g., failed physical machines, offline physical machines, etc.) and physical machines not matching the service requirements of the first to-be-deployed virtual machine instance (e.g., if it needs to thermally migrate the first to-be-deployed virtual machine instance, the physical machines that are not suitable for thermal migration may be filtered out), and so on.

In an embodiment, when obtaining the score of matching degree, the step of determining the score of matching degree between each physical machine and the first to-be-deployed virtual machine instance based on the optimal resource distribution information can be carried out only for the remaining physical machines after filtering, which will not be described in details here.

In an embodiment, the method further includes: when it is detected that a preset triggering condition is satisfied, or when an instruction of arranging the virtual machine instances deployed on the plurality of physical machines in the cloud computing system is received, the optimal deployment of the virtual machine instances deployed on the plurality of physical machines in the cloud computing system is determined, and some of the deployed virtual machine instances are migrated according to the optimal deployment.

In this embodiment, the virtual machine instances deployed on the plurality of physical machine in the cloud computing system are arranged, that is, secondary scheduling, which can be used as a supplement to the above-mentioned virtual machine scheduling method (primary scheduling) to realize rearrangement of the deployed virtual machine instances in the cloud computing system to further improve the rationality of overall resource distribution. Triggering conditions for secondary scheduling can be preset, for example, the secondary scheduling can be triggered periodically, that is, the triggering conditions are preset as time conditions. Alternatively, the resource utilization rate of the cloud computing system can be acquired, and the secondary scheduling can be triggered when the resource utilization rate reaches a preset threshold, or other preset triggering conditions are also possible, which is not limited here. In addition, the secondary scheduling can also be triggered manually, for example, the secondary scheduling can be triggered when an instruction of arranging the virtual machine instances deployed on the plurality of physical machines in the cloud computing system is received, that is, when a triggering instruction of the secondary scheduling is received. During the secondary scheduling, the optimal deployment of the deployed virtual machine instances in the range of all the physical machines in the cloud computing system can be calculated according to the information (such as specifications, service requirements, etc.) of the virtual machine instances deployed on the plurality of physical machines in the cloud computing system. The optimal deployment can be the deployment with the highest resource utilization rate; of course, the migration cost of the deployed virtual machine instances can also be taken into consideration, that is, the optimal deployment can be determined by considering both the resource utilization rate and the migration cost.

After determining the optimal deployment of the deployed virtual machine instance, the deployed virtual machine that does not satisfy the optimal deployment can be migrated based on the optimal deployment. For example, if the deployed virtual machine a is currently deployed on the physical machine A and it is determined that the deployed virtual machine a needs to be deployed on the physical machine B according to the optimal deployment, the deployed virtual machine a can be migrated from the physical machine A to the physical machine B. In this embodiment, based on the above-mentioned virtual machine scheduling process of S201-S203, the resource allocation is more reasonable, and the efficiency and accuracy of resource scheduling are improved. On this basis, the number of deployed virtual machines that need to be migrated during secondary scheduling is greatly reduced, and the migration cost is reduced.

Optionally, when the optimal deployment is determined in the secondary scheduling, the virtual machine instances deployed and expected to be deployed on the plurality of physical machines can also be considered at the same time; that is, according to the virtual machine instances deployed and expected to be deployed on the plurality of physical machines in the cloud computing system, the optimal deployment of the deployed virtual machine instances and the virtual machine instances expected to be deployed can be calculated in the range of all the physical machines in the cloud computing system, which can improve the rationality of overall resource distribution. At the same time, it also provides a basis for the primary scheduling process, in which the specifications and numbers of virtual machine instances expected to be deployed on idle resources of the plurality of physical machines (idle resources after secondary scheduling) can be determined, from the optimal deployment, as the optimal resource distribution information of the plurality of physical machines in the above embodiment.

FIG. 5 is a block diagram illustrating a structure of a virtual machine scheduling apparatus provided by an embodiment of the present disclosure, corresponding to the virtual machine scheduling method of the above embodiments. For convenience of explanation, only parts related to the embodiments of the present disclosure are illustrated. Referring to FIG. 5, the virtual machine scheduling apparatus 500 includes a pre-scheduling unit 501, an evaluation unit 502, and a scheduling unit 503.

The pre-scheduling unit 501 is configured to acquire optimal resource distribution information of a plurality of physical machines in a cloud computing system, wherein the optimal resource distribution information includes specifications and numbers of specifications of virtual machine instances expected to be deployed on idle resources of the plurality of physical machines.

The evaluation unit 502 is configured to, for a first to-be-deployed virtual machine instance, determine a score of matching degree between each physical machine and the first to-be-deployed virtual machine instance based on the optimal resource distribution information.

The scheduling unit 503 is configured to determine the physical machine with a highest score of matching degree as a host machine of the first to-be-deployed virtual machine instance, for resource allocation.

In one or more embodiments of the present disclosure, when acquiring the optimal resource distribution information of the plurality of physical machines in the cloud computing system, the pre-scheduling unit 501 is configured to:
acquire all specifications of the virtual machine instances expected to be deployed on idle resources of the plurality of physical machines and numbers corresponding to different specifications;
acquire number information of idle resources of each physical machine; and
determine the optimal resource distribution information according to all specifications of the virtual machine instances expected to be deployed, the numbers corresponding to different specifications, and the number information of idle resources of each physical machine.

In one or more embodiments of the present disclosure, when determining the optimal resource distribution information according to all specifications of the virtual machine instances expected to be deployed, the numbers corresponding to different specifications, and the number information of idle resources of each physical machine, the pre-scheduling unit 501 is configured to:
simulate to deploy the virtual machine instances expected to be deployed on the idle resources of the plurality of physical machines, and determine the specifications and the numbers of the specifications of the virtual machine instances expected to be deployed on idle resources of each physical machine that achieve a highest resource utilization rate as the optimal resource distribution information.

In one or more embodiments of the present disclosure, when determining the score of matching degree between each physical machine and the first to-be-deployed virtual machine instance based on the optimal resource distribution information, the evaluation unit 502 is configured to:
determine the score of matching degree between each physical machine and the first to-be-deployed virtual machine instance according to the optimal resource distribution information, information of each physical machine and information of the first to-be-deployed virtual machine instance.

In one or more embodiments of the present disclosure, when determining the score of matching degree between each physical machine and the first to-be-deployed virtual machine instance according to the optimal resource distribution information, the information of each physical machine and the information of the first to-be-deployed virtual machine instance, the evaluation unit 502 is configured to:
determine a first sub-score of matching degree between the first physical machine and the first to-be-deployed virtual machine instance according to the specifications and the numbers of the specifications of the virtual machine instances expected to be deployed on the idle resources of the first physical machine in the optimal resource distribution information, and a specification of the first to-be-deployed virtual machine instance; wherein the first sub-score is a score obtained by evaluating the matching degree between the first physical machine and the first to-be-deployed virtual machine instance based on the optimal resource distribution information;
determine a second sub-score of matching degree between the first physical machine and the first to-be-deployed virtual machine instance according to the information of the first physical machine and the information of the first to-be-deployed virtual machine instance; wherein the second sub-score is a score obtained by evaluating the matching degree between the first physical machine and the first to-be-deployed virtual machine instance based on the information of the first physical machine and the information of the first to-be-deployed virtual machine instance; and
add up the first sub-score and the second sub-score to obtain a sum as the score of matching degree between the first physical machine and the first to-be-deployed virtual machine instance.

In one or more embodiments of the present disclosure, when determining the first sub-score of matching degree between the first physical machine and the first to-be-deployed virtual machine instance according to the specifications and the numbers of the specifications of the virtual machine instances expected to be deployed on the idle resources of the first physical machine in the optimal resource distribution information and the specification of the first to-be-deployed virtual machine instance, the evaluation unit 502 is configured to:
judge whether the specification of the first to-be-deployed virtual machine instance is included in the specifications of the virtual machine instances expected to be deployed on the idle resources of the first physical machine;
if not, the first sub-score is determined as 0; or
if so, the first sub-score is determined according to the number of the specification of the first to-be-deployed virtual machine instance included in the specifications of the virtual machine instances expected to be deployed on the idle resources of the first physical machine; wherein the greater the number of the specification of the first to-be-deployed virtual machine instance included in the specifications of the virtual machine instances expected to be deployed on the idle resources of the first physical machine, the higher the first sub-score.

In one or more embodiments of the present disclosure, when determining the second sub-score of matching degree between the first physical machine and the first to-be-deployed virtual machine instance according to the information of the first physical machine and the information of the first to-be-deployed virtual machine instance, the evaluation unit 502 is configured to obtain one or more of the following scores, and determine a sum of the obtained scores as the second sub-score:
a score of stacking degree of the first physical machine determined according to a stacking degree of the first physical machine; and/or,
a performance score of the first physical machine determined according to a performance of the first physical machine; and/or,
a score of satisfaction degree of the first physical machine for service requirements of the first to-be-deployed virtual machine instance determined according to the service requirements of the first to-be-deployed virtual machine instance; and/or,
an affinity score of the first physical machine determined according to a preset service tag of the first physical machine and a service tag of the first to-be-deployed virtual machine instance; and/or,
a score of instance number of the first physical machine determined according to a number of deployed virtual machine instances of the first physical machine.

In one or more embodiments of the present disclosure, before determining the score of matching degree between each physical machine and the first to-be-deployed virtual machine instance based on the optimal resource distribution information, the evaluation unit 502 is further configured to:
filter out unavailable physical machines from the plurality of physical machines in the cloud computing system, wherein the unavailable physical machines include one or more of the following: physical machines with idle resources less than the specification of the first to-be-deployed virtual machine instance, physical machines with abnormal working conditions, and physical machines not matching the service requirements of the first to-be-deployed virtual machine instance;
when determining the score of matching degree between each physical machine and the first to-be-deployed virtual machine instance based on the optimal resource distribution information, the evaluation unit 502 is configured to:
for the remaining physical machines after filtering, determine the score of matching degree between each physical machine and the first to-be-deployed virtual machine instance based on the optimal resource distribution information.

In one or more embodiments of the present disclosure, the scheduling unit 503 is further configured to:
determine an optimal deployment of the deployed virtual machine instances on the plurality of physical machines in the cloud computing system and migrate some of the deployed virtual machines according to the optimal deployment, when it is detected that a preset triggering condition is satisfied or when an instruction of arranging the deployed virtual machine instances on the plurality of physical machines in the cloud computing system is received.

The apparatus provided in this embodiment can be used to implement the technical solution of the above method embodiments with similar implementation principle and technical effects, so the details of this embodiment are not repeated here.

Referring to FIG. 6, it shows a schematic structural diagram of an electronic device 600 suitable for implementing the embodiments of the present disclosure, which may be a terminal device or a server. The terminal device in the embodiment of the present disclosure may include, but be not limited to, a mobile terminal such as a mobile phone, a notebook computer, a digital broadcast receiver, a PDA (Personal Digital Assistant), a PAD (Portable Android Device), a PMP (Portable Multimedia Player) and a vehicle-mounted terminal (such as vehicle-mounted navigation terminal), and a fixed terminal such as a digital TV and a desktop computer. The electronic device 500 shown in FIG. 6 is just an example, and should not bring any limitation to the functions and application scopes of the embodiments of the present disclosure.

As shown in FIG. 6, the electronic device 600 may include a processing device (such as a central processing unit, a graphics processor, etc.) 601, which may perform various appropriate actions and processes according to a program stored in a read-only memory (ROM) 602 or a program loaded from a storage device 608 into a random-access memory (RAM) 603. In the RAM 603, various programs and data required for the operation of the electronic device 600 are also stored. The processing device 601, the ROM 602 and the RAM 603 are connected to each other through a bus 604. An input/output (I/O) interface 605 is also connected to the bus 604.

Generally, the following devices can be connected to the I/O interface 605: an input device 606 including, for example, a touch screen, a touch pad, a keyboard, a mouse, a camera, a microphone, an accelerometer, a gyroscope, etc.; an output device 607 including, for example, a liquid crystal display (LCD), a speaker, a vibrator, etc.; a storage device 608 including, for example, a magnetic tape, a hard disk, etc.; and a communication device 609. The communication device 609 may allow the electronic device 600 to have wireless or wired communication with other devices to exchange data. Although FIG. 6 shows an electronic device 600 with various devices, it is not required to implement or have all the devices as shown. More or fewer devices may alternatively be implemented or provided.

According to an embodiment of the present disclosure, the process described above with reference to the flowchart can be implemented as a computer software program. For example, an embodiment of the present disclosure includes a computer program product including a computer program carried on a computer-readable medium, and the computer program contains program codes for executing the method shown in the flowchart. In such an embodiment, the computer program can be downloaded and installed from the network through the communication device 609, or installed from the storage device 608 or from the ROM 602. When the computer program is executed by the processing device 601, the above functions defined in the method of the embodiment of the present disclosure are performed.

The computer-readable medium mentioned above in the present disclosure can be a computer-readable signal medium or a computer-readable storage medium or any combination of the two. The computer-readable storage medium can be, for example, but not limited to, an electrical, magnetic, optical, electromagnetic, infrared, or semiconductor system, apparatus or device, or a combination of any of the above. Examples of the computer-readable storage medium may include, but are not limited to, an electrical connection with one or more wires, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, a computer-readable storage medium can be any tangible medium containing or storing a program, which can be used by or in combination with an instruction execution system, apparatus or device. In the present disclosure, a computer-readable signal medium may include a data signal propagated in baseband or as part of a carrier wave, in which computer-readable program codes are carried. This propagated data signal can take many forms, including but not limited to electromagnetic signals, optical signals or any suitable combination of the above. A computer-readable signal medium can also be any computer-readable medium other than a computer-readable storage medium, which can send, propagate or transmit a program for use by or in connection with an instruction execution system, apparatus or device. The program codes contained in the computer-readable medium can be transmitted by any suitable medium, including but not limited to: electrical wires, optical cables, RF (radio frequency) and the like, or any suitable combination of the above.

The computer-readable medium described above may be included in the electronic device described above; or it can exist alone without being assembled into the electronic device.

The computer-readable medium described above carries one or more programs, which, when executed by the electronic device, cause the electronic device to perform the method shown in the above embodiments.

Computer program codes for performing the operations of the present disclosure may be written in one or more programming languages or their combinations, including but not limited to object-oriented programming languages, such as Java, Smalltalk, C++, and conventional procedural programming languages, such as “C” language or similar programming languages. The program code can be completely executed on the user's computer, partially executed on the user's computer, executed as an independent software package, partially executed on the user's computer and partially executed on a remote computer, or completely executed on a remote computer or server. In the case involving a remote computer, the remote computer may be connected to a user's computer through any kind of network, including a local area network (LAN) or a wide area network (WAN), or may be connected to an external computer (for example, through the Internet using an Internet service provider).

The flowcharts and block diagrams in the drawings illustrate the architecture, functions and operations of possible implementations of systems, methods and computer program products according to various embodiments of the present disclosure. In this regard, each block in the flowchart or block diagram may represent a module, a program segment, or a part of code that contains one or more executable instructions for implementing specified logical functions. It should also be noted that in some alternative implementations, the functions annotated in the blocks may occur in a different order than those annotated in the drawings. For example, two blocks shown in succession may actually be executed substantially in parallel, and they may sometimes be executed in the reverse order, depending on the functions involved. It should also be noted that each block in the block diagrams and/or flowcharts, and combinations of blocks in the block diagrams and/or flowcharts, can be implemented by a dedicated hardware-based system that performs specified functions or operations, or by a combination of dedicated hardware and computer instructions.

The units involved in the embodiment described in the present disclosure can be realized by software or hardware. The name of the unit does not constitute the limitation of the unit itself in some cases.

The functions described above in the present disclosure may be at least partially performed by one or more hardware logic components. For example, without limitation, exemplary types of hardware logic components that can be used include: Field Programmable Gate Array (FPGA), Application Specific Integrated Circuit (ASIC), Application Specific Standard Product (ASSP), System on Chip (SOC), Complex Programmable Logic Device (CPLD) and so on.

In the context of present disclosure, a machine-readable medium may be a tangible medium that may contain or store a program for use by or in connection with an instruction execution system, apparatus or device. The machine-readable medium may be a machine-readable signal medium or a machine-readable storage medium. A machine-readable medium may include, but is not limited to, an electronic, magnetic, optical, electromagnetic, infrared, or semiconductor system, device or equipment, or any suitable combination of the above. More specific examples of the machine-readable storage medium may include an electrical connection based on one or more wires, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above.

According to one or more embodiments of the present disclosure, there is provided a virtual machine scheduling method, including:
acquiring optimal resource distribution information of a plurality of physical machines in a cloud computing system, wherein the optimal resource distribution information includes specifications and numbers of specifications of virtual machine instances expected to be deployed on idle resources of the plurality of physical machines;
for a first to-be-deployed virtual machine instance, determining a score of matching degree between each physical machine and the first to-be-deployed virtual machine instance based on the optimal resource distribution information; and
determining the physical machine with the highest score of matching degree as a host machine of the first to-be-deployed virtual machine instance for resource allocation.

According to one or more embodiments of the present disclosure, the acquiring the optimal resource distribution information of the plurality of physical machines in the cloud computing system includes:
acquiring all specifications of the virtual machine instances expected to be deployed on idle resources of the plurality of physical machines and numbers corresponding to different specifications;
acquiring number information of idle resources of each physical machine; and
determining the optimal resource distribution information according to all specifications of the virtual machine instances expected to be deployed, the numbers corresponding to different specifications, and the number information of idle resources of each physical machine.

According to one or more embodiments of the present disclosure, the determining the optimal resource distribution information according to all specifications of the virtual machine instances expected to be deployed, the numbers corresponding to different specifications, and the number information of idle resources of each physical machine, including:
simulating to deploy the virtual machine instances expected to be deployed on the idle resources of the plurality of physical machines, and determining the specifications and the numbers of the specifications of the virtual machine instances expected to be deployed on idle resources of each physical machine that achieve a highest resource utilization rate as the optimal resource distribution information.

According to one or more embodiments of the present disclosure, the determining the score of matching degree between each physical machine and the first to-be-deployed virtual machine instance based on the optimal resource distribution information includes:
determining the score of matching degree between each physical machine and the first to-be-deployed virtual machine instance according to the optimal resource distribution information, information of each physical machine and information of the first to-be-deployed virtual machine instance.

According to one or more embodiments of the present disclosure, the determining the score of matching degree between each physical machine and the first to-be-deployed virtual machine instance according to the optimal resource distribution information, the information of each physical machine and the information of the first to-be-deployed virtual machine instance, including:
determining a first sub-score of matching degree between the first physical machine and the first to-be-deployed virtual machine instance according to the specifications and the numbers of the specifications of the virtual machine instances expected to be deployed on the idle resources of the first physical machine in the optimal resource distribution information, and the specification of the first to-be-deployed virtual machine instance; wherein the first sub-score is a score obtained by evaluating the matching degree between the first physical machine and the first to-be-deployed virtual machine instance based on the optimal resource distribution information;
determining a second sub-score of matching degree between the first physical machine and the first to-be-deployed virtual machine instance according to the information of the first physical machine and the information of the first to-be-deployed virtual machine instance; wherein the second sub-score is a score obtained by evaluating the matching degree between the first physical machine and the first to-be-deployed virtual machine instance based on the information of the first physical machine and the information of the first to-be-deployed virtual machine instance; and
adding up the first sub-score and the second sub-score to obtain a sum as the score of matching degree between the first physical machine and the first to-be-deployed virtual machine instance.

According to one or more embodiments of the present disclosure, the determining the first sub-score of matching degree between the first physical machine and the first to-be-deployed virtual machine instance according to the specifications and the numbers of the specifications of the virtual machine instances expected to be deployed on the idle resources of the first physical machine in the optimal resource distribution information, and the specification of the first to-be-deployed virtual machine instance, including:
judging whether the specification of the first to-be-deployed virtual machine instance is included in the specifications of the virtual machine instances expected to be deployed on the idle resources of the first physical machine;
if not, determining the first sub-score as 0; or
if so, determining the first sub-score according to the number of the specification of the first to-be-deployed virtual machine instance included in the specifications of the virtual machine instances expected to be deployed on the idle resources of the first physical machine; wherein the greater the number of the specification of the first to-be-deployed virtual machine instance included in the specifications of the virtual machine instances expected to be deployed on the idle resources of the first physical machine is, the higher the first sub-score will be.

According to one or more embodiments of the present disclosure, the determining the second sub-score of matching degree between the first physical machine and the first to-be-deployed virtual machine instance according to the information of the first physical machine and the information of the first to-be-deployed virtual machine instance, including:
obtaining one or more of the following scores, and determining a sum of the obtained scores as the second sub-score:
a score of stacking degree of the first physical machine determined according to a stacking degree of the first physical machine; and/or,
a performance score of the first physical machine determined according to a performance of the first physical machine; and/or,
a score of satisfaction degree of the first physical machine for service requirements of the first to-be-deployed virtual machine instance determined according to the service requirements of the first to-be-deployed virtual machine instance; and/or,
an affinity score of the first physical machine determined according to a preset service tag of the first physical machine and a service tag of the first to-be-deployed virtual machine instance; and/or,
a score of instance number of the first physical machine determined according to the number of deployed virtual machine instances of the first physical machine.

According to one or more embodiments of the present disclosure, before the determining the score of matching degree between each physical machine and the first to-be-deployed virtual machine instance based on the optimal resource distribution information, it further includes:
filtering out unavailable physical machines from the plurality of physical machines in the cloud computing system, wherein the unavailable physical machines include one or more of the following: physical machines with idle resources less than the specification of the first to-be-deployed virtual machine instance, physical machines with abnormal working conditions, and physical machines not matching the service requirements of the first to-be-deployed virtual machine instance;
the determining the score of matching degree between each physical machine and the first to-be-deployed virtual machine instance based on the optimal resource distribution information includes:
for the remaining physical machines after filtering, determining the score of matching degree between each physical machine and the first to-be-deployed virtual machine instance based on the optimal resource distribution information.

According to one or more embodiments of the present disclosure, the method further includes:
determining an optimal deployment of the deployed virtual machine instances on the plurality of physical machines in the cloud computing system and migrating some of the deployed virtual machines according to the optimal deployment, when it is detected that a preset triggering condition is satisfied or when an instruction of arranging the deployed virtual machine instances on the plurality of physical machines in the cloud computing system is received.

According to one or more embodiments of the present disclosure, there is provided a virtual machine scheduling apparatus, including:
a pre-scheduling unit, configured to acquire optimal resource distribution information of a plurality of physical machines in a cloud computing system, wherein the optimal resource distribution information includes specifications and numbers of the specifications of virtual machine instances expected to be deployed on idle resources of the plurality of physical machines;
an evaluation unit, configured to, for a first to-be-deployed virtual machine instance, determine a score of matching degree between each physical machine and the first to-be-deployed virtual machine instance based on the optimal resource distribution information; and
a scheduling unit, configured to determine the physical machine with a highest score of matching degree as a host machine of the first to-be-deployed virtual machine instance for resource allocation.

According to one or more embodiments of the present disclosure, when acquiring the optimal resource distribution information of a plurality of physical machines in a cloud computing system, the pre-scheduling unit is configured to:
acquire all specifications of the virtual machine instances expected to be deployed on idle resources of the plurality of physical machines and numbers corresponding to different specifications;
acquire number information of idle resources of each physical machine; and
determine the optimal resource distribution information according to all specifications of the virtual machine instances expected to be deployed, the numbers corresponding to different specifications, and the number information of idle resources of each physical machine.

According to one or more embodiments of the present disclosure, when determining the optimal resource distribution information according to all specifications of the virtual machine instances expected to be deployed, the numbers corresponding to different specifications, and the number information of idle resources of each physical machine, the pre-scheduling unit is configured to:
simulate to deploy the virtual machine instances expected to be deployed on the idle resources of the plurality of physical machines, and determine the specifications and the numbers of the specifications of the virtual machine instances expected to be deployed on idle resources of each physical machine that achieve a highest resource utilization rate as the optimal resource distribution information.

According to one or more embodiments of the present disclosure, when determining the score of matching degree between each physical machine and the first to-be-deployed virtual machine instance based on the optimal resource distribution information, the evaluation unit is configured to:
determine the score of matching degree between each physical machine and the first to-be-deployed virtual machine instance according to the optimal resource distribution information, information of each physical machine and information of the first to-be-deployed virtual machine instance.

According to one or more embodiments of the present disclosure, when determining the score of matching degree between each physical machine and the first to-be-deployed virtual machine instance according to the optimal resource distribution information, the information of each physical machine and the information of the first to-be-deployed virtual machine instance, the evaluation unit is configured to:
determine a first sub-score of matching degree between the first physical machine and the first to-be-deployed virtual machine instance according to the specifications and the numbers of the specifications of the virtual machine instances expected to be deployed on the idle resources of the first physical machine in the optimal resource distribution information, and the specification of the first to-be-deployed virtual machine instance; wherein the first sub-score is a score obtained by evaluating the matching degree between the first physical machine and the first to-be-deployed virtual machine instance based on the optimal resource distribution information;
determine a second sub-score of matching degree between the first physical machine and the first to-be-deployed virtual machine instance according to the information of the first physical machine and the information of the first to-be-deployed virtual machine instance; wherein the second sub-score is a score obtained by evaluating the matching degree between the first physical machine and the first to-be-deployed virtual machine instance based on the information of the first physical machine and the information of the first to-be-deployed virtual machine instance; and
add up the first sub-score and the second sub-score to obtain a sum as the score of matching degree between the first physical machine and the first to-be-deployed virtual machine instance.

According to one or more embodiments of the present disclosure, when determining the first sub-score of matching degree between the first physical machine and the first to-be-deployed virtual machine instance according to the specifications and the number of the specifications of the virtual machine instances expected to be deployed on the idle resources of the first physical machine in the optimal resource distribution information, and the specification of the first to-be-deployed virtual machine instance, the evaluation unit is configured to:
judge whether the specification of the first to-be-deployed virtual machine instance is included in the specifications of the virtual machine instances expected to be deployed on the idle resources of the first physical machine;
if not, the first sub-score is determined as 0; or
if so, the first sub-score is determined according to the number of the specification of the first to-be-deployed virtual machine instance included in the specifications of the virtual machine instances expected to be deployed on the idle resources of the first physical machine; wherein the greater the number of the specification of the first to-be-deployed virtual machine instance included in the specifications of the virtual machine instances expected to be deployed on the idle resources of the first physical machine is, the higher the first sub-score will be.

According to one or more embodiments of the present disclosure, when determining the second sub-score of matching degree between the first physical machine and the first to-be-deployed virtual machine instance according to the information of the first physical machine and the information of the first to-be-deployed virtual machine instance, the evaluation unit is configured to:
obtain one or more of the following scores, and determine a sum of the obtained scores as the second sub-score:
a score of stacking degree of the first physical machine determined according to a stacking degree of the first physical machine; and/or,
a performance score of the first physical machine determined according to a performance of the first physical machine; and/or,
a score of satisfaction degree of the first physical machine for service requirements of the first to-be-deployed virtual machine instance determined according to the service requirements of the first to-be-deployed virtual machine instance; and/or,
an affinity score of the first physical machine determined according to a preset service tag of the first physical machine and a service tag of the first to-be-deployed virtual machine instance; and/or,
a score of instance number of the first physical machine determined according to the number of deployed virtual machine instances of the first physical machine.

According to one or more embodiments of the present disclosure, before determining the score of matching degree between each physical machine and the first to-be-deployed virtual machine instance based on the optimal resource distribution information, the evaluation unit is further configured to:
filter out unavailable physical machines from the plurality of physical machines in the cloud computing system, wherein the unavailable physical machines include one or more of the following: physical machines with idle resources less than the specification of the first to-be-deployed virtual machine instance, physical machines with abnormal working conditions, and physical machines not matching the service requirements of the first to-be-deployed virtual machine instance;
when determining the score of matching degree between each physical machine and the first to-be-deployed virtual machine instance based on the optimal resource distribution information, the evaluation unit is configured to:
for the remaining physical machines after filtering, determine the score of matching degree between each physical machine and the first to-be-deployed virtual machine instance based on the optimal resource distribution information.

According to one or more embodiments of the present disclosure, the scheduling unit is further configured to:
determine an optimal deployment of the deployed virtual machine instances on the plurality of physical machines in the cloud computing system and migrate some of the deployed virtual machines according to the optimal deployment, when it is detected that a preset triggering condition is satisfied or when an instruction of arranging the deployed virtual machine instances on the plurality of physical machines in the cloud computing system is received.

According to one or more embodiments of the present disclosure, there is provided an electronic device including at least one processor and a memory stored with computer-executable instructions;
the at least one processor executes the computer-executable instructions stored in the memory, so that the at least one processor executes the virtual machine scheduling method as described in the above embodiment and in the various possible designs of the above embodiment.

According to one or more embodiments of the present disclosure, a non-transient computer-readable storage medium is provided, in which computer-executable instructions are stored, and when a processor executes the computer-executable instructions, the processer executes the virtual machine scheduling method as described in the above embodiment and in the various possible designs of the above embodiment.

According to one or more embodiments of the present disclosure, there is provided a computer program product including computer-executed instructions, and when a processor executes the computer-executable instructions, the processer executes the virtual machine scheduling method as described in the above embodiment and in the various possible designs of the above embodiment.

The above description only refers to exemplary embodiments of the present disclosure and the explanation of the technical principles as applied. It should be understood by those skilled in the art that the disclosure scope involved in the present disclosure is not limited to the technical solutions formed by the specific combination of the above technical features, but also covers other technical solutions formed by any combination of the above technical features or their equivalent features without departing from the above disclosure concept, for example, technical solutions formed by replacing the above features with (but not limited to) technical features having similar functions disclosed in the present disclosure.

Furthermore, although the operations are depicted in a particular order, this should not be understood as requiring that these operations be performed in the order as shown or in a sequential order. Under certain circumstances, multitasking and parallel processing may be beneficial. Likewise, although several specific implementation details are contained in the above discussion, these should not be construed as limiting the scope of the present disclosure. Some features described in the context of separate embodiments can also be combined in a single embodiment. On the contrary, various features described in the context of a single embodiment can also be implemented in multiple embodiments individually or in any suitable sub-combination.

Although the subject matter has been described in language specific to structural features and/or methodological logical acts, it should be understood that the subject matter defined in the appended claims is not necessarily limited to the specific features or acts described above. On the contrary, the specific features and actions described above are only exemplary forms of implementing the claims.

1. A virtual machine scheduling method, comprising:
acquiring optimal resource distribution information of a plurality of physical machines in a cloud computing system, wherein the optimal resource distribution information comprises specifications and numbers of the specifications of virtual machine instances expected to be deployed on idle resources of the plurality of physical machines;
for a first to-be-deployed virtual machine instance, determining a score of matching degree between each physical machine of the plurality of physical machines and the first to-be-deployed virtual machine instance based on the optimal resource distribution information; and
determining the physical machine with a highest score of matching degree as a host machine of the first to-be-deployed virtual machine instance, for resource allocation.

2. The method according to claim 1, wherein the acquiring the optimal resource distribution information of the plurality of physical machines in the cloud computing system comprises:
acquiring all specifications of the virtual machine instances expected to be deployed on the idle resources of the plurality of physical machines and numbers corresponding to different specifications;
acquiring number information of idle resources of each physical machine; and
determining the optimal resource distribution information according to all specifications of the virtual machine instances expected to be deployed, the numbers corresponding to different specifications, and the number information of idle resources of each physical machine.

3. The method according to claim 2, wherein the determining the optimal resource distribution information according to all specifications of the virtual machine instances expected to be deployed, the numbers corresponding to different specifications, and the number information of idle resources of each physical machine, comprising:
simulating to deploy the virtual machine instances expected to be deployed on the idle resources of the plurality of physical machines, and determining the specifications and the numbers of the specifications of the virtual machine instances expected to be deployed on idle resources of each physical machine that achieve a highest resource utilization rate as the optimal resource distribution information.

4. The method according to claim 1, wherein the determining the score of matching degree between each physical machine and the first to-be-deployed virtual machine instance based on the optimal resource distribution information comprises:
determining the score of matching degree between each physical machine and the first to-be-deployed virtual machine instance according to the optimal resource distribution information, information of each physical machine and information of the first to-be-deployed virtual machine instance.

5. The method according to claim 4, wherein the determining the score of matching degree between each physical machine and the first to-be-deployed virtual machine instance according to the optimal resource distribution information, the information of each physical machine and the information of the first to-be-deployed virtual machine instance comprises:
determining a first sub-score of matching degree between the first physical machine and the first to-be-deployed virtual machine instance according to the specifications and the numbers of the specifications of the virtual machine instances expected to be deployed on the idle resources of the first physical machine in the optimal resource distribution information, and a specification of the first to-be-deployed virtual machine instance; wherein the first sub-score is a score obtained by evaluating the matching degree between the first physical machine and the first to-be-deployed virtual machine instance based on the optimal resource distribution information;
determining a second sub-score of matching degree between the first physical machine and the first to-be-deployed virtual machine instance according to the information of the first physical machine and the information of the first to-be-deployed virtual machine instance; wherein the second sub-score is a score obtained by evaluating the matching degree between the first physical machine and the first to-be-deployed virtual machine instance based on the information of the first physical machine and the information of the first to-be-deployed virtual machine instance; and
adding up the first sub-score and the second sub-score to obtain a sum as the score of matching degree between the first physical machine and the first to-be-deployed virtual machine instance.

6. The method according to claim 5, wherein the determining the first sub-score of matching degree between the first physical machine and the first to-be-deployed virtual machine instance according to the specifications and the numbers of the specifications of the virtual machine instances expected to be deployed on the idle resources of the first physical machine in the optimal resource distribution information, and the specification of the first to-be-deployed virtual machine instance, comprising:
judging whether the specification of the first to-be-deployed virtual machine instance is included in the specifications of the virtual machine instances expected to be deployed on the idle resources of the first physical machine;
in response to the specification of the first to-be-deployed virtual machine instance being not included in the specifications of the virtual machine instances expected to be deployed on the idle resources of the first physical machine, determining the first sub-score as 0; or
in response to the specification of the first to-be-deployed virtual machine instance being included in the specifications of the virtual machine instances expected to be deployed on the idle resources of the first physical machine, determining the first sub-score according to a number of the specification of the first to-be-deployed virtual machine instance included in the specifications of the virtual machine instances expected to be deployed on the idle resources of the first physical machine; wherein
the greater the number of the specification of the first to-be-deployed virtual machine instance included in the specifications of the virtual machine instances expected to be deployed on the idle resources of the first physical machine, the higher the first sub-score.

7. The method according to claim 5, wherein the determining the second sub-score of matching degree between the first physical machine and the first to-be-deployed virtual machine instance according to the information of the first physical machine and the information of the first to-be-deployed virtual machine instance comprises:
obtaining one or more of the following scores, and determining a sum of the obtained scores as the second sub-score:
a score of stacking degree of the first physical machine, a performance score of the first physical machine, a score of satisfaction degree of the first physical machine for service requirement of the first to-be-deployed virtual machine instance, an affinity score of the first physical machine with respect to the first to-be-deployed virtual machine instance, and a score of instance number of deployed virtual machine instances of the first physical machine.

8. The method according to claim 1, wherein before the determining the score of matching degree between each physical machine and the first to-be-deployed virtual machine instance based on the optimal resource distribution information, further comprising:
filtering out unavailable physical machines from the plurality of physical machines in the cloud computing system, wherein the unavailable physical machines comprise one or more of the following: a physical machine with idle resource less than a specification of the first to-be-deployed virtual machine instance, a physical machine with abnormal working condition, and a physical machine not matching service requirement of the first to-be-deployed virtual machine instance;
the determining the score of matching degree between each physical machine and the first to-be-deployed virtual machine instance based on the optimal resource distribution information comprises:
for the remaining physical machines after filtering, determining the score of matching degree between each physical machine and the first to-be-deployed virtual machine instance based on the optimal resource distribution information.

9. The method according to claim 1, further comprising:
in response to detecting that a preset triggering condition is satisfied, or in response to receiving an instruction of arranging deployed virtual machine instances on the plurality of physical machines in the cloud computing system, determining an optimal deployment of the deployed virtual machine instances on the plurality of physical machines in the cloud computing system and migrating a part of the deployed virtual machine instances according to the optimal deployment.

10. An electronic device, comprising:
at least one processor; and
a memory stored with computer-executable instructions; wherein
the at least one processor is configured to execute the computer-executable instructions stored in the memory to realize a virtual machine scheduling method, comprising:
acquiring optimal resource distribution information of a plurality of physical machines in a cloud computing system, wherein the optimal resource distribution information comprises specifications and numbers of the specifications of virtual machine instances expected to be deployed on idle resources of the plurality of physical machines;
for a first to-be-deployed virtual machine instance, determining a score of matching degree between each physical machine of the plurality of physical machines and the first to-be-deployed virtual machine instance based on the optimal resource distribution information; and
determining the physical machine with a highest score of matching degree as a host machine of the first to-be-deployed virtual machine instance, for resource allocation.

11. The electronic device according to claim 10, wherein in the virtual machine scheduling method, the acquiring the optimal resource distribution information of the plurality of physical machines in the cloud computing system comprises:
acquiring all specifications of the virtual machine instances expected to be deployed on the idle resources of the plurality of physical machines and numbers corresponding to different specifications;
acquiring number information of idle resources of each physical machine; and
determining the optimal resource distribution information according to all specifications of the virtual machine instances expected to be deployed, the numbers corresponding to different specifications, and the number information of idle resources of each physical machine.

12. The electronic device according to claim 11, wherein in the virtual machine scheduling method, the determining the optimal resource distribution information according to all specifications of the virtual machine instances expected to be deployed, the numbers corresponding to different specifications, and the number information of idle resources of each physical machine, comprising:
simulating to deploy the virtual machine instances expected to be deployed on the idle resources of the plurality of physical machines, and determining the specifications and the numbers of the specifications of the virtual machine instances expected to be deployed on idle resources of each physical machine that achieve a highest resource utilization rate as the optimal resource distribution information.

13. The electronic device according to claim 10, wherein in the virtual machine scheduling method, the determining the score of matching degree between each physical machine and the first to-be-deployed virtual machine instance based on the optimal resource distribution information comprises:
determining the score of matching degree between each physical machine and the first to-be-deployed virtual machine instance according to the optimal resource distribution information, information of each physical machine and information of the first to-be-deployed virtual machine instance.

14. The electronic device according to claim 13, wherein in the virtual machine scheduling method, the determining the score of matching degree between each physical machine and the first to-be-deployed virtual machine instance according to the optimal resource distribution information, the information of each physical machine and the information of the first to-be-deployed virtual machine instance, comprising:
determining a first sub-score of matching degree between the first physical machine and the first to-be-deployed virtual machine instance according to the specifications and the numbers of the specifications of the virtual machine instances expected to be deployed on the idle resources of the first physical machine in the optimal resource distribution information, and a specification of the first to-be-deployed virtual machine instance; wherein the first sub-score is a score obtained by evaluating the matching degree between the first physical machine and the first to-be-deployed virtual machine instance based on the optimal resource distribution information;
determining a second sub-score of matching degree between the first physical machine and the first to-be-deployed virtual machine instance according to the information of the first physical machine and the information of the first to-be-deployed virtual machine instance; wherein the second sub-score is a score obtained by evaluating the matching degree between the first physical machine and the first to-be-deployed virtual machine instance based on the information of the first physical machine and the information of the first to-be-deployed virtual machine instance; and
adding up the first sub-score and the second sub-score to obtain a sum as the score of matching degree between the first physical machine and the first to-be-deployed virtual machine instance.

15. The electronic device according to claim 14, wherein in the virtual machine scheduling method, the determining the first sub-score of matching degree between the first physical machine and the first to-be-deployed virtual machine instance according to the specifications and the numbers of the specifications of the virtual machine instances expected to be deployed on the idle resources of the first physical machine in the optimal resource distribution information, and the specification of the first to-be-deployed virtual machine instance, comprising:
judging whether the specification of the first to-be-deployed virtual machine instance is included in the specifications of the virtual machine instances expected to be deployed on the idle resources of the first physical machine;
in response to the specification of the first to-be-deployed virtual machine instance being not included in the specifications of the virtual machine instances expected to be deployed on the idle resources of the first physical machine, determining the first sub-score as 0; or
in response to the specification of the first to-be-deployed virtual machine instance being included in the specifications of the virtual machine instances expected to be deployed on the idle resources of the first physical machine, determining the first sub-score according to a number of the specification of the first to-be-deployed virtual machine instance included in the specifications of the virtual machine instances expected to be deployed on the idle resources of the first physical machine; wherein
the greater the number of the specification of the first to-be-deployed virtual machine instance included in the specifications of the virtual machine instances expected to be deployed on the idle resources of the first physical machine, the higher the first sub-score.

16. The electronic device according to claim 14, wherein in the virtual machine scheduling method, the determining the second sub-score of matching degree between the first physical machine and the first to-be-deployed virtual machine instance according to the information of the first physical machine and the information of the first to-be-deployed virtual machine instance comprises:
obtaining one or more of the following scores, and determining a sum of the obtained scores as the second sub-score:
a score of stacking degree of the first physical machine, a performance score of the first physical machine, a score of satisfaction degree of the first physical machine for service requirement of the first to-be-deployed virtual machine instance, an affinity score of the first physical machine with respect to the first to-be-deployed virtual machine instance, and a score of instance number of deployed virtual machine instances of the first physical machine.

17. The electronic device according to claim 10, wherein in the virtual machine scheduling method, before the determining the score of matching degree between each physical machine and the first to-be-deployed virtual machine instance based on the optimal resource distribution information, further comprising:
filtering out unavailable physical machines from the plurality of physical machines in the cloud computing system, wherein the unavailable physical machines comprise one or more of the following: a physical machine with idle resource less than a specification of the first to-be-deployed virtual machine instance, a physical machine with abnormal working condition, and a physical machine not matching service requirement of the first to-be-deployed virtual machine instance;
the determining the score of matching degree between each physical machine and the first to-be-deployed virtual machine instance based on the optimal resource distribution information comprises:
for the remaining physical machines after filtering, determining the score of matching degree between each physical machine and the first to-be-deployed virtual machine instance based on the optimal resource distribution information.

18. The electronic device according to claim 10, wherein the virtual machine scheduling method further comprises:
in response to detecting that a preset triggering condition is satisfied, or in response to receiving an instruction of arranging deployed virtual machine instances on the plurality of physical machines in the cloud computing system, determining an optimal deployment of the deployed virtual machine instances on the plurality of physical machines in the cloud computing system and migrating a part of the deployed virtual machine instances according to the optimal deployment.

19. A non-transient computer-readable storage medium in which computer-executable instructions are stored, wherein
the computer-executable instructions, when executed by a processor, are configured to cause the processor to realize a virtual machine scheduling method, comprising:
acquiring optimal resource distribution information of a plurality of physical machines in a cloud computing system, wherein the optimal resource distribution information comprises specifications and numbers of the specifications of virtual machine instances expected to be deployed on idle resources of the plurality of physical machines;
for a first to-be-deployed virtual machine instance, determining a score of matching degree between each physical machine of the plurality of physical machines and the first to-be-deployed virtual machine instance based on the optimal resource distribution information; and
determining the physical machine with a highest score of matching degree as a host machine of the first to-be-deployed virtual machine instance, for resource allocation.

20. The non-transient computer-readable storage medium according to claim 19, wherein in the virtual machine scheduling method, the acquiring the optimal resource distribution information of the plurality of physical machines in the cloud computing system comprises:
acquiring all specifications of the virtual machine instances expected to be deployed on the idle resources of the plurality of physical machines and numbers corresponding to different specifications;
acquiring number information of idle resources of each physical machine; and
determining the optimal resource distribution information according to all specifications of the virtual machine instances expected to be deployed, the numbers corresponding to different specifications, and the number information of idle resources of each physical machine.
